(19) United States
(12) Patent Application Publication
(10) Pub. No.: US 2024/0201479 A1
(43) Pub. Date: Jun. 20, 2024

(54) Electrowetting Apparatus and Method Thereof

(71) Applicant: Compertum Microsystems Inc., Hsinchu City (TW)

(72) Inventor: Francis Piu MAN, Hsinchu City (TW)

(73) Assignee: Compertum Microsystems Inc., Hsinchu City (TW)

(21) Appl. No.: 18/084,558

(22) Filed: Dec. 20, 2022

(51) Int. Cl. G02B 26/00; G02B 1/18; G02B 7/00

(52) U.S. Cl. CPC G02B 26/005; G02B 1/18; G02B 7/008

(57) ABSTRACT

An electrowetting apparatus includes an optical substrate, a plurality of electrodes disposed on the optical substrate, and a hydrophilic layer disposed on the optical substrate. A plurality of voltages are applied to at least part of the plurality of electrodes to move a droplet out of the electrowetting apparatus after the droplet appears on the hydrophilic layer.

### BACKGROUND OF THE INVENTION

### 1. Field of the Invention

The present invention relates to an electrowetting apparatus and method thereof, and more particularly, to an electrowetting apparatus and method configured to clean the surface of an object using the electrowetting effect.

### 2. Description of the Prior Art

Operation of optical systems is facilitated by clean optical paths, which can be hindered by droplets generated on the surface of an object (e.g., a camera, a windshield, a window, a mirror, or a light source lens). In particular, humid weather conditions with rain or mist can obstruct or interfere with optical transmission through the object in outdoor applications.

With the advent of Autonomous Driving Assist System (ADAS), automobiles demand systems capable of reliably sensing and identifying objects, hazards, and obstacles in navigation. Among all the systems, camera and Light Detection and Ranging (LiDAR) system are optical sensing devices that require an optically-transparent window allowing optical signals to transmit and receive between optical device and its environment. Raindrops may adhere to such window interfering optical signals.

There is still room for improvement when it comes to self-cleaning.

### SUMMARY OF THE INVENTION

It is therefore a primary objective of the present invention to provide an electrowetting apparatus and method thereof so as to clean the surface of an object using the electrowetting effect.

The present invention discloses an electrowetting apparatus comprising an optical substrate, a plurality of electrodes disposed on the optical substrate, and a hydrophilic layer disposed on the optical substrate. A plurality of voltages are applied to at least part of the plurality of electrodes to move a droplet out of the electrowetting apparatus after the droplet appears on the hydrophilic layer.

The present invention discloses a method for an electrowetting apparatus comprising applying a first voltage to a first electrode of a plurality of electrodes at a first time instant, and applying a second voltage to a second electrode of the plurality of electrodes at a second time instant. A hydrophilic layer is disposed on the plurality of electrodes. The first voltage or the second voltage is higher than a third voltage of a third electrode of the plurality of electrodes to move a droplet on the hydrophilic layer, and the first electrode is disposed adjacent to and between the second electrode and the third electrode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electrowetting apparatus and a droplet according to an embodiment of the present invention.

FIG. 2 is a schematic diagram illustrating the operation of the electrowetting apparatus shown in FIG. 1.

FIG. 3 is a schematic diagram illustrating the amplitude of deformation/vibration versus frequencies.

FIG. 4 is a schematic diagram of an electrowetting apparatus and a droplet according to an embodiment of the present invention.

### DETAILED DESCRIPTION

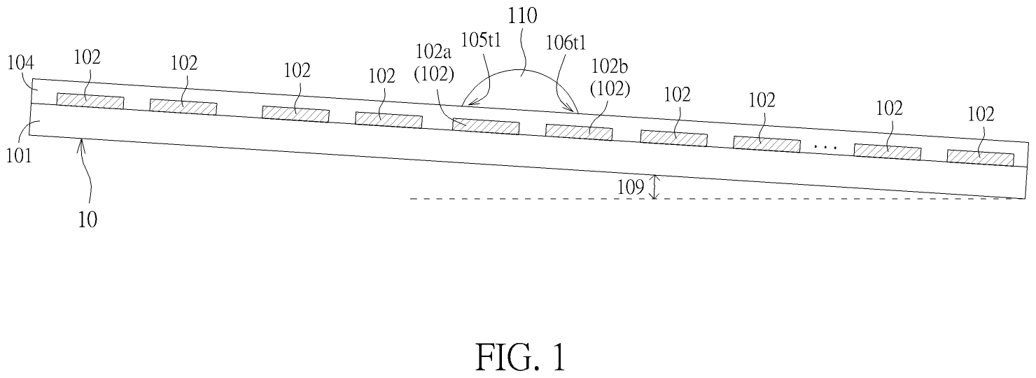

FIG. 1 is a schematic diagram of an electrowetting apparatus 10 and a droplet 110 according to an embodiment of the present invention. The electrowetting apparatus 10 may include an optical substrate 101, a plurality of electrodes 102 (e.g., 102a and 102b), and a hydrophilic layer 104. The electrowetting apparatus 10 is configured to clean/dry the outer surface of the electrowetting apparatus 10, thereby preventing a droplet (e.g., 110) from affecting light propagation through the optical substrate 101. The electrowetting apparatus 10 may be a self-cleaning window for an optical sensing device (e.g., Light Detection and Ranging (LiDAR)).

The optical substrate 101 may be, for example, a windshield, a window, a mirror, or a cover glass. The optical substrate 101 may cover an object such as a camera, a light source, a lens set, or a display wall. The optical substrate 101 may be optically transparent to the wavelength of light that is transmitted and received by the optical sensing device.

The hydrophilic layer 104 may be laminated on the electrodes 102 to fill the space between the electrodes 102. The hydrophilic layer 104 may be made of material(s) having affinity with fluid such as water.

The electrodes 102 may be successively arranged on the surface of the optical substrate 101. The electrodes 102 may be regularly arranged to form a specific pattern. For example, the electrodes 102 may be equidistantly spaced and arranged in a one-dimensional array (or a two-dimensional array). The shape of the pattern formed by the electrodes 102 is not limited. Each of the electrodes 102 may be in a linear or an annular shape. The electrodes 102 may be optically transparent to the wavelength of light that is transmitted and received by the optical sensing device. The electrodes 102 may be made of metal threads or metal oxides such as indium tin oxide (ITO) or aluminum-doped zinc oxide (AZO).

When the droplet 110 appears on the electrodes 102, it forms contact angles (e.g., 105t1, 106t1) with the hydrophilic layer 104. The contact angles (e.g., 105t1, 106t1), which are measured from the front surface of the electrowetting apparatus 10 to the tangent of the surface of the droplet 110 in contact with the front surface of the electrowetting apparatus 10, are used to quantify the interaction of the electrowetting apparatus 10 and the droplet 110, which is undesirable. Usually, the contact angles are identical. The hydrophilic layer 104 may have the contact angles less than 90 degrees.

As shown in FIG. 1, there may be a tilt angle 109 between the normal vector to the front surface of the electrowetting apparatus 10 and the normal vector to the surface of the earth. When the optical substrate 101 is tilted at the tilt angle 109, contact angles (e.g., 105t1, 106t1) may be different due to gravitational pull. As the tilt angle 109 increases, the contact angle differential increases and at a certain time instant, the droplet 110 may move.

Electrowetting is a method to induce contact angle differentials. To expel the droplet 110 from the surface of the electrowetting apparatus 10, voltage(s) may be applied to (one/some/all of) the electrodes 102. The droplet 110 that is poorly adhering due to voltage changes may be easily dislodged. The electrowetting apparatus 10 may apply a voltage sequence based on the position of the droplet 110.

In an embodiment, the electrowetting apparatus 10 may alternately apply direct current (DC) voltage(s) to (one/some/all of) the electrodes 102 to remove the droplet 110. The droplet 110 may move from an electrode 102 to which a high voltage is applied towards another electrode 102 to which a low voltage is applied, and thus eventually leave the electrowetting apparatus 10.

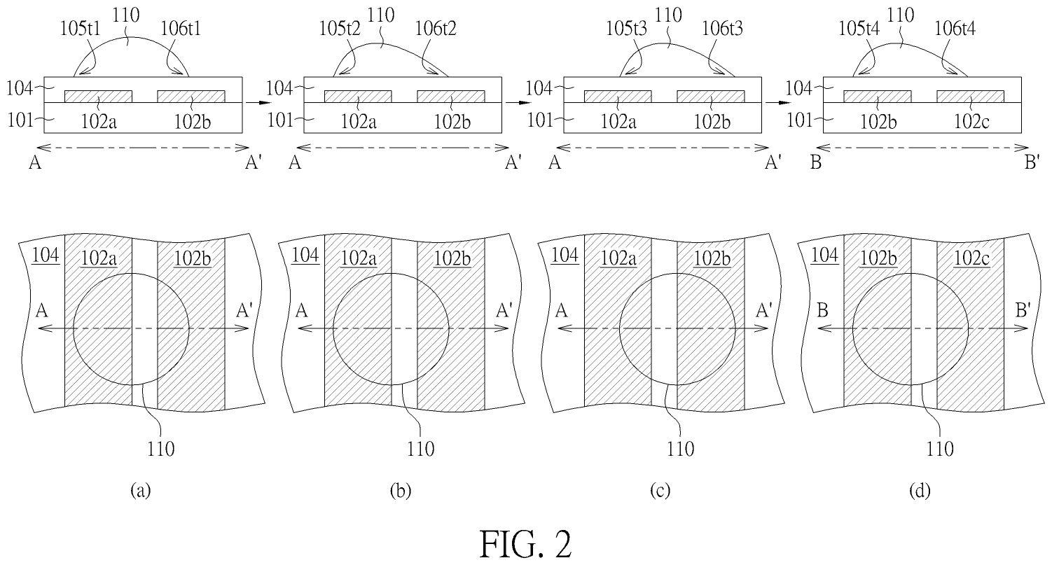

For example, FIG. 2 is a schematic diagram illustrating the operation of the electrowetting apparatus 10. In (a) of FIG. 2, the droplet 110 is located above and between the electrodes 102a and 102b. A high voltage (e.g., a positive voltage) may be applied to the electrode 102a, and other electrodes 102 (e.g., 102b) may be at a low voltage (e.g., a ground voltage) (at a first time instant). For example, a DC voltage may be applied between the two adjacent electrodes (e.g., 102a and 102b) such that the electrode 102a has higher potential than the electrode 102b.

The contact angle (e.g., 105t1 or 106t1) of one electrode 102 is a function of the voltage applied to the electrode 102 based on Lippmann-Young equation, which satisfies cosα(V)=cosα(0)+ε₀ε V²/2γd, where α(V) represents the contact angle as a function of the applied voltage V, ε₀ represents the vacuum permittivity, ε represents the dielectric constant of the hydrophilic layer 104, γ represents the interfacial tension between the droplet 110 and the ambient air interface, and d represents the thickness of hydrophilic layer 104. That is, the voltage(s) applied to the electrode(s) 102 may be a function of the surface property of the hydrophilic layer 104 and the inclination of the electrowetting apparatus 10.

The contact angles 105t1 and 106t1 may be, for example, 85 and 85 degrees respectively. In (b) of FIG. 2, a higher voltage may be applied to the electrode 102a, and other electrodes 102 (e.g., 102b) may remain at the low voltage. The voltage difference may reshape the droplet 110 such that the contact angle 105t1 may become the receding angle and the contact angle 106t1 may become the advancing angle. The receding angle may increase from 105t1 to 105t2 and the advancing angle may reduce from 106t1 to 106t2. The contact angles 105t2 and 106t2 may be, for example, 85 and 25 degrees respectively. When the contact angle differential (e.g., between the contact angles 105t2 and 106t2) is large enough, the droplet 110 may start to move.

The droplet 110 may move toward the electrode 102b as shown in (c) of FIG. 2. The voltage applied to the electrode 102a may still be low, and the voltage applied to the electrode 102b may still be high (or may be higher than its previous voltage). The contact angles 105t3 and 106t3 may be, for example, 85 and 25 degrees respectively. In (d) of FIG. 2, the high voltage may be applied to the electrode 102c, and the voltage of the electrode 102b may become the low voltage (at a second time instant). Other electrodes 102 (e.g., 102a) may be at the low voltage. The droplet 110 may thus move further and eventually to the outside of the electrowetting apparatus 10. The length of time between the first time instant and the second time instant may be a function of the speed of the droplet 110.

In an embodiment, it is desirable that the layer that contacts/interacts with the droplet 110 is hydrophobic (i.e., the contact angle being greater than 90 degree) in order to create huge contact angle differentials for given applied voltage.

In another embodiment, the present invention can also be used in a layer that contacts/interacts with the droplet 110 is hydrophilic (e.g., the hydrophilic layer 104). For the hydrophilic layer 104 that has relatively high contact angles (e.g., about 80-85 degrees), the contact angle differential can be high enough to move the droplet 110 by manipulating the voltage(s) applied to the electrode(s) 102. Generally, the voltage(s) applied to the electrode(s) 102 under the hydrophilic layer 104 may be higher than the voltage(s) applied to the electrode(s) under a hydrophobic layer.

In yet another embodiment, the present invention can also be used in a layer that contacts/interacts with the droplet 110 is hydrophilic (e.g., the hydrophilic layer 104). For the hydrophilic layer 104 that has relatively high contact angles (e.g., about 80-85 degrees), the contact angle differential can be high enough to move the droplet 110 by tilting the electrowetting apparatus 10 and manipulating the voltage(s) applied to the electrode(s) 102. Generally, the voltage(s) applied to the electrode(s) 102 under the hydrophilic layer 104 may be higher than the voltage(s) applied to the electrode(s) under a hydrophobic layer.

As shown in FIG. 1, the side(s) of each electrode 102 may be parallel to the line of intersection between the surface of the earth and a plane parallel to the front surface of the electrowetting apparatus 10. Voltage(s) may be applied to (one/some/all of) the electrodes 102 the slope of the electrowetting apparatus 10 (i.e., the height of the electrodes 102) with respected to the surface of the earth. For example, higher voltage may be applied to lower electrode 102 (e.g., the electrode 102b if compared to the electrode 102a).

In another embodiment, besides DC voltages, the electrowetting apparatus 10 may apply (low-frequency) alternating current (AC) voltages to (one/some/all of) the electrodes 102 to remove the droplet 110. The peak and zero crossing of (the waveform of) the voltage applied to one electrode 102 (e.g., 102a) may not coincide the peak and zero crossing of (the waveform of) the voltage applied to its adjacent electrode 102 (e.g., 102b). Similarly, the voltage applied to the latter (e.g., the electrode 102b) and the voltage applied to its adjacent electrode 102 (e.g., 102c) may be out of phase. The phase difference between any two adjacent electrodes 102 may be in a range of 0 to 90 degrees.

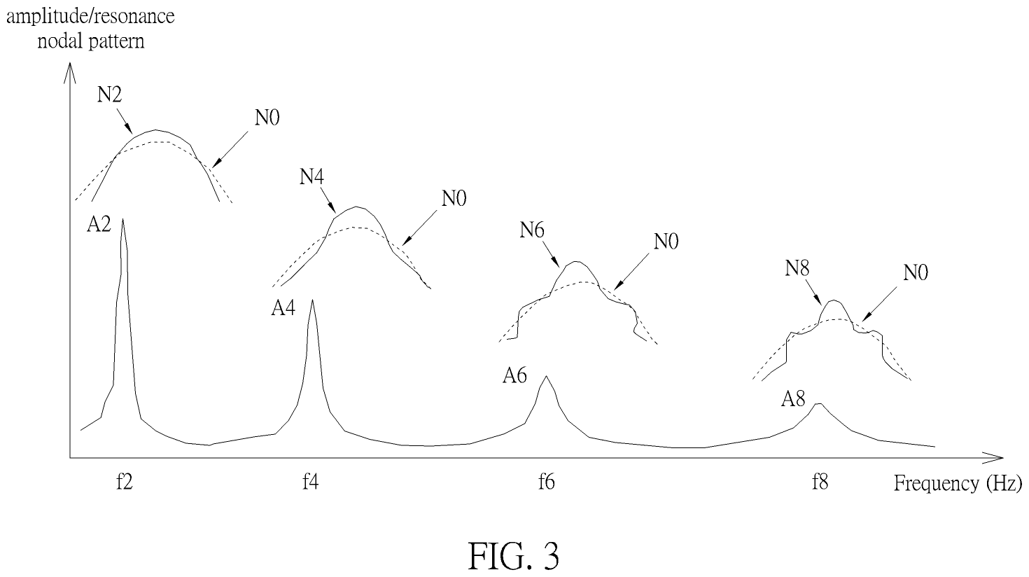

In another embodiment, the droplet 110 may start to oscillate as the contact angles change (e.g., from the contact angle 105t1 to the contact angle 105t2) with the AC voltages applied to the electrodes (e.g., the electrodes 102a and 102b). The oscillation pattern of the droplet 110 is strongly dependent on the frequencies of the AC voltages. In addition, the oscillation of the droplet 110 resonates at certain resonant frequency/frequencies. For example, FIG. 3 is a schematic diagram illustrating the amplitude of deformation/vibration versus frequencies. At certain resonant frequencies, the resonance of the droplet 110 causes the deformation or vibration of the droplet 110. For instance, the droplet 110 which is not under resonance has the shape N0. At resonant frequencies (e.g., f2, f4, f6, and f8), corresponding resonance nodal patterns (e.g., N2, N4, N6, and N8) of the droplet 110 are formed. As the resonant frequency increases, the resonance nodal pattern may have more nodes and the amplitude (e.g., A2, A4, A6, or A8) of the resonance nodal pattern (i.e., the height of the droplet 110) may decrease (e.g., A8<A6<A4<A2) as shown in FIG. 3. Such deformation of the droplet 110 may be symmetrical and may not cause any net motion of the droplet 110. But when the electrowetting apparatus 10 inclines (such that the advanced and receded contact angles occur), the vigorous vibration of the droplet 110 may detach/dislodge the droplet 110 from the hydrophilic layer 104. In an embodiment, the frequency of the AC voltage(s) applied to the electrode(s) 102 may be equal to the resonant frequency of the droplet 110.

In a word, the combination of the surface property of the hydrophilic layer 104, the inclination of the electrowetting apparatus 10, and voltage(s) applied to the electrode(s) 102 may increase the probability that the droplet 110 on the surface of the electrowetting apparatus 10 will roll off of the surface or be poorly adhered.

The electrowetting apparatus 10 may further include a control circuit, which is configured to collect data related to the location of a droplet on the surface of the hydrophilic layer 104 (e.g., the droplet 110), or whether there is a droplet on the surface of the hydrophilic layer 104. For example, the control circuit may detect a droplet by monitoring the capacitance of the electrode 102. When a droplet is present between the two adjacent electrodes 102 (e.g., 102a and 102b), the (mutual) capacitance between the two adjacent electrodes 102 may change. When a droplet is located on one of the electrodes 102 (e.g., 102a), the (self) capacitance of the electrode 102 with respect to the ground may change. The bigger the size of the droplet 110, the higher the capacitance change may be. That is, the presence of a droplet induces capacitance changes, thereby indicating the presence/location of a droplet on the surface of the hydrophilic layer 104.

The control circuit may be further configured to utilize the collected data and apply a voltage sequence to the electrodes 102 in order to move the droplet 110 from one location to another. For example, the capacitance changes enable the control circuit to make a determination regarding the voltage(s) of the electrode(s) 102. (Otherwise, the electrodes 102 may be maintained at the low voltage.)

The control circuit may start detecting droplet(s) or applying voltage(s) to the electrode(s) 102 after a user input a cleaning request. The control circuit may stop detecting droplet(s) or applying voltage(s) to the electrode(s) 102 after a predetermined time or a user input a cancellation request.

The surface property of the hydrophilic layer 104, the inclination of the electrowetting apparatus 10, and voltage(s) applied to the electrode(s) 102 may reduce the size of the droplet 110 such that when the surface of the electrowetting apparatus 10 is subjected to heat, the remaining fluid in the droplet 102 evaporates. Heater(s) on the optical substrate 101 may provide heat to the surface of the electrowetting apparatus 10 and thus remove the droplet 110 when evaporation occurs.

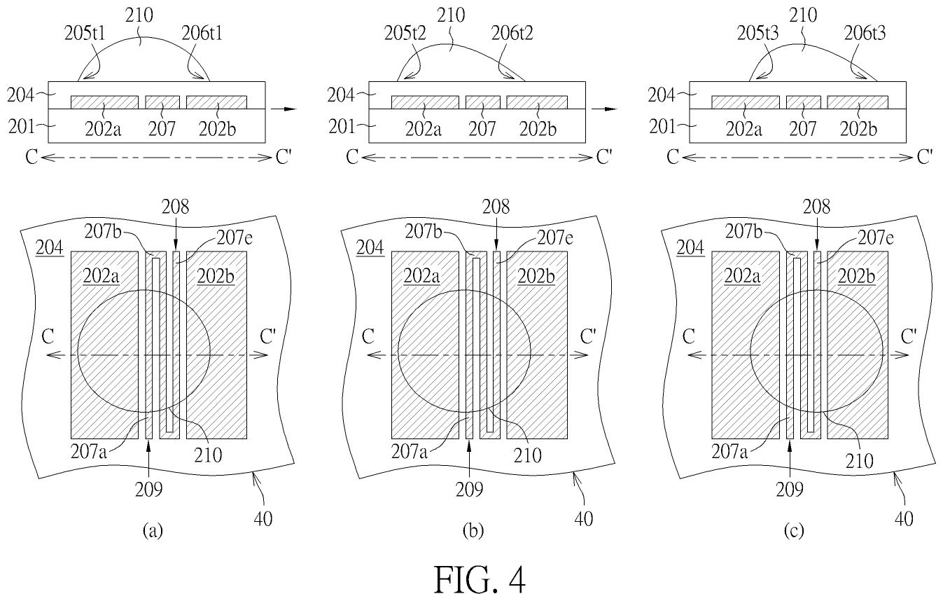

For example, FIG. 4 is a schematic diagram of an electrowetting apparatus 40 and a droplet 110 according to an embodiment of the present invention. The electrowetting apparatus 10 and 40 may have similar structure/elements but the electrowetting apparatus 40 further includes a plurality of heaters 207 configured to evaporate a droplet (e.g., 210).

As shown in FIG. 4, each heater 207 is meandering and includes a plurality of straight segments (e.g., 207a, 207b, and 207e). Each straight segment may be a rectangle with rounded corner(s) or squared corner(s). Heat may be input from edge 208 or 209 of one heater 207.

The heaters 207 are disposed on the optical substrate 201 as the electrodes 202. The electrodes 202 and the heaters 207 are alternately disposed or mutually interleaved. In an embodiment, at least one heater 207 is disposed between two adjacent electrodes 202, and no heater is disposed between another two adjacent electrodes 202. In another embodiment, at least one electrode 202 is disposed between two adjacent heaters 207.

With the heaters 207, the electrowetting apparatus 40 may heat the droplet 202 to evaporate the droplet 202 from the surface of the electrowetting apparatus 40.

To sum up, when a droplet appears on electrodes of the present invention, the droplet may move towards the edge of an electrowetting apparatus of the present invention by applying voltages to the electrodes to generate sufficient contact angle differentials between advancing and receding contact angle of the droplet.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrowetting apparatus, comprising:
an optical substrate;
a plurality of electrodes, disposed on the optical substrate; and
a hydrophilic layer, disposed on the optical substrate,
wherein a plurality of voltages are applied to at least part of the plurality of electrodes to move a droplet out of the electrowetting apparatus after the droplet appears on the hydrophilic layer.

2. The electrowetting apparatus of claim 1, further comprising:
a plurality of heater, disposed on the optical substrate and configured to evaporate the droplet, wherein the plurality of electrodes and the plurality of heater are alternately disposed.

3. The electrowetting apparatus of claim 2, wherein each of the plurality of heaters is meandering and comprises a plurality of straight segments with squared corners.

4. The electrowetting apparatus of claim 2, wherein at least one of the plurality of heaters is disposed between two adjacent ones of the plurality of electrodes, and no heater is disposed between another two adjacent ones of the plurality of electrodes.

5. The electrowetting apparatus of claim 2, wherein at least one of the plurality of electrodes is disposed between two adjacent ones of the plurality of heaters.

6. The electrowetting apparatus of claim 1, wherein a first voltage of the plurality of voltages is applied to a first electrode of the plurality of electrodes at a first time instant, a second voltage of the plurality of voltages is applied to a second electrode of the plurality of electrodes at a second time instant, the first voltage or the second voltage is higher than a third voltage of a third electrode of the plurality of electrodes to move the droplet on the hydrophilic layer, and the first electrode is disposed adjacent to and between the second electrode and the third electrode.

7. The electrowetting apparatus of claim 6, wherein the droplet moves from the third electrode to the first electrode after the first voltage is applied to the first electrode, the droplet moves from the first electrode to the second electrode after the second voltage is applied to the second electrode.

8. The electrowetting apparatus of claim 6, wherein the second electrode is at a fourth voltage at the first time instant, the first electrode is at the fourth voltage at the second time instant, and the second voltage is equal to the first voltage.

9. The electrowetting apparatus of claim 1, wherein a first alternating current (AC) voltage is applied to a first electrode of the plurality of electrodes, a second AC voltage is applied to a second electrode of the plurality of electrodes, and the first AC voltage and the second AC voltage are out of phase, a frequency of the first AC voltage or the second AC voltage equals to a resonant frequency of the droplet.

10. The electrowetting apparatus of claim 1, wherein a first electrode is selected from the plurality of electrodes to apply a first voltage of the plurality of voltages to the first electrode after the droplet around the first electrode is found.

11. A method, for an electrowetting apparatus, comprising:
applying a first voltage to a first electrode of a plurality of electrodes at a first time instant, wherein a hydrophilic layer is disposed on the plurality of electrodes; and
applying a second voltage to a second electrode of the plurality of electrodes at a second time instant,
wherein the first voltage or the second voltage is higher than a third voltage of a third electrode of the plurality of electrodes to move a droplet on the hydrophilic layer, and the first electrode is disposed adjacent to and between the second electrode and the third electrode.

12. The electrowetting apparatus of claim 11, further comprising:
evaporating the droplet with at least one of a plurality of heater, wherein the plurality of heater are disposed under the hydrophilic layer.

13. The electrowetting apparatus of claim 11, wherein the droplet moves from the third electrode to the first electrode after the first voltage is applied to the first electrode, the droplet moves from the first electrode to the second electrode after the second voltage is applied to the second electrode, and the second voltage is higher than or equal to the first voltage.

14. The electrowetting apparatus of claim 11, wherein the second electrode is at a fourth voltage at the first time instant, the first electrode is at the fourth voltage at the second time instant, and the second voltage is equal to the first voltage.

15. The electrowetting apparatus of claim 11, further comprising:
detecting the droplet;
determining that the droplet is around the first electrode; and
selecting the first electrode from the plurality of electrodes to apply the first voltage to the first electrode.
